(19) United States
(12) Patent Application Publication
(10) Pub. No.: US 2015/0273780 A1
(43) Pub. Date: Oct. 1, 2015

(54) DEVICE FOR ADAPTING THE CONTROL OF A SYSTEM FOR PROCESSING FILM WEBS

(71) Applicant: Uhlmann Pac-Systeme GmbH & Co. KG, Laupheim (DE)

(72) Inventors: Reinhard Hintraeger, Neu-Ulm (DE); Anton Ege, Achstetten (DE)

(21) Appl. No.: 14/668,340

(22) Filed: Mar. 25, 2015

(30) Foreign Application Priority Data
Mar. 26, 2014 (EP) 14161814.0
Mar. 5, 2015 (EP) 15157834.1

(51) Int. Cl. B31B 1/04

(52) U.S. Cl. CPC B31B 1/04

(57) ABSTRACT

The device for adapting the control of a system for processing film webs, especially the control of a blister pack machine, comprises a central control unit, which supplies a plurality of work stations of the system with control commands, and a device for detecting splices in the film web. The device for detecting splices comprises a distance-measuring unit, which generates sensor signals, which track the change in the thickness of the film web. An analog evaluation unit with a differentiator for differentiating the sensor signals and a downline comparator for comparing the voltage signals output by the differentiator with at least one previously determined limit value outputs decision signals on the basis of the comparison to the control unit, which adapts the control commands for the work stations accordingly.

### RELATED APPLICATIONS

The present patent document claims the benefit of priority to European Patent Application No. EP 14161814.0, filed Mar. 26, 2014, and EP 15157834.1, filed Mar. 5, 2015, the entire contents of each of which are incorporated herein by reference.

### FIELD AND BACKGROUND OF THE INVENTION

The invention relates to a device for adapting the control of a system for processing film webs, especially the control of a blister pack machine.

In the pharmaceutical packaging industry, medications such as tablets or capsules are packaged in blister packs. A blister pack consists of a form sheet, which is formed in a blister pack machine, and a lidding sheet, sealed onto the form sheet after the form sheet has been filled. These sheets or films are delivered from the manufacturer in rolls and they are therefore in the form of webs of film material. To minimize the down times which occur in the production process at the end of the roll, the end of the film web in question is butt-joined to the beginning of the new roll by means of an adhesive strip, for example. The exact position of this splice must be known to the blister pack machine. On the basis of this information, appropriate measures such as omitting the step of forming the film web in the area of the splice, omitting the step of filling the film web in the area of the splice, and implementing the step of ejecting the affected blister packs after the stamping step, can be taken at various work stations of the blister pack machine during the packaging process.

To detect such splices, the preference today is to use ultrasound systems for lidding sheet webs, wherein the adhesive strips applied at the splices cause an increase in the damping. This technique does not function properly, however, in the case of the form sheet webs, which are usually much thicker, because here the thickness ratio between the form sheet web and the adhesive strip can be as much as 1:10. This means that the adhesive strip, which is thinner than the film web, is undetectable against the background noise of the measurement. For this reason, optical systems in the form of contrast scanners, for example, are used for the form sheet webs.

Every time there is a change in format, i.e., whenever the system has to be changed over from one product to be packaged to another product and there is thus a change in the set of web properties, both ultrasound systems and optical systems must be taught how to work with the new web and splice materials. This is time-consuming and also represents a risk in terms of pharmaceutical safety.

Optical systems in particular run up against their limits in the case of printed and highly reflective sheet materials. There is also the possibility that the rolls of sheet material have been produced by splicing individual webs together. When the web manufacturer now uses a material for the adhesive strip which differs from the material learned by the system, detection may prove impossible. In the case of optical scanning, furthermore, it is necessary, when non-transparent film webs are spliced, to use two different detection systems, one for the top surface of the web, the other for the bottom surface, because an adhesive joint can be applied to both the top surface and the bottom surface of the sheet web.

Distance-measuring units for measuring sheet thickness are also known from the prior art.

### SUMMARY OF THE INVENTION

It is an object of the present invention to provide a device for adapting the control of a system for processing film webs, especially the control of a blister pack machine, which is pharmaceutically safe and also embodies a format-independent system which requires no learning process.

According to an aspect of the invention, the device for adapting the control of a system for processing film webs comprises a central control unit, which is set up to supply a plurality of work stations of the system with control commands, and a device for detecting splices in the film web. The device for detecting splices in the film web comprises a distance-measuring unit comprising a measuring element, which moves mechanically as a function of the thickness of the film web and which is set up to generate sensor signals which track the change in thickness of the film web. In addition, the device for detecting splices comprises an analog evaluation unit, which is connected to the distance-measuring unit and which receives the sensor signals from the distance-measuring unit, wherein the analog evaluation unit comprises at least one differentiator for differentiating the sensor signals and for generating voltage signals corresponding to the speed of the measuring element and also a comparator, downline from the differentiator, for comparing the voltage signals generated by the differentiator with at least one previously determined limit value. On the basis of the comparison, the analog evaluation unit outputs decision signals to the control unit, and the control unit is set up to adapt the control commands for the work stations on the basis of the decision signals received from the analog evaluation unit.

With this configuration, it is possible to guarantee the reliable detection of the splices even if the film web moves in stepwise fashion. In addition, the system requires no new learning process whenever the type of film or the type of splice is changed. The system described here, furthermore, guarantees that splices can be detected both on the top surface and on the bottom surface of the sheet web to be monitored. The analog evaluation is based on a differentiation of the sensor signals of the distance-measuring unit, as a result of which only the abrupt changes caused by the edge of a splice are recognized as relevant to the decision. Processes which proceed more slowly in time such as production-related changes in sheet thickness, for example, are masked out as a result.

In a preferred embodiment, the comparator is configured as a window comparator. As a result, voltage signals from the differentiator which lie in either a positive or a negative direction outside a symmetric window region centered on zero can be subjected to further processing as positive decision criteria. The same distance-measuring unit can thus detect both the ascending flank and the descending flank of a splice.

To improve the signal quality of the square-wave signals transmitted by the comparator and to increase the signal strength, the analog evaluation unit preferably comprises a pulse-forming circuit downline from the comparator.

In a preferred embodiment, the analog evaluation unit also comprises a device for function monitoring. The freedom of movement of the mechanical components, the intactness of the sensor cable, and the functionality of the sensors are monitored by this device.

The measuring element is preferably guided in a plain bearing. This allows the measuring element to move smoothly.

In a preferred embodiment, the distance-measuring unit is configured as an inductive analog sensor, which, in addition to the measuring element, comprises a sensor element, wherein the measuring element of the distance-measuring unit is configured as a proximity element, which is movably supported relative to the sensor element in a direction perpendicular to the transport direction of the film web. Thus the sensor element itself comprises no moving wear parts, which has a positive effect on the service life and availability of the system.

It is also advantageous for the sensor element and the measuring element to be functionally connected to each other in such a way that a change in the distance between the measuring element and the sensor element brings about a change in the damping of the sensor element by the measuring element. This results in improved measurement dynamics, as a result of which the measuring certainty is increased in turn.

If the measuring element comprises, in its lower area, a roller, which rolls along the film web, the contact between the measuring element and the film web will be guaranteed without any danger of damage to the web.

In an especially preferred embodiment, a second distance-measuring unit is arranged downstream, with respect to the transport direction of the film web, from the first distance-measuring unit. This redundant system guarantees reliable detection even in cases where the web is traveling very slowly, as it does in an intermittently moving machine which must first run up to speed and then slow to a stop during each cycle, because at least one of the two distance-measuring units will be able to detect the splice while the film web has already begun to travel, or is still traveling, at a speed sufficient for evaluation.

It is advantageous in this case for the distance between the first distance-measuring unit and the second distance-measuring unit to be in the range of 10-50 mm, and preferably in the range of 15-30 mm, in the transport direction of the sheet web. This offers the advantage that the two distance-measuring units can be mounted on the same bracket, and in addition the sensor signals of the two distance-measuring units can be easily correlated.

In an alternative embodiment of the invention, the device for adapting the control of a system for processing film webs can comprise a central control unit, which is set up to supply a plurality of work stations of the system with control commands, and two distance-measuring units, which are arranged a previously determined distance apart, in series in the transport direction of the film web. Each distance-measuring unit comprises a measuring element mechanically movable as a function of the thickness of the film web and is set up to generate sensor signals which track the change in thickness of the film web. The control unit is set up to evaluate the sensor signals obtained from the two distance-measuring units and to adapt the control commands for the work stations on the basis of the evaluation of these sensor signals.

### BRIEF DESCRIPTION OF THE DRAWINGS

Additional advantages and features of the present invention can be derived from the following description, which refers to the drawings:

FIG. 1 shows a schematic diagram of the structure of one embodiment of the device according to the invention for adapting the control of a system for processing film webs;

FIGS. 2a and 2b show a cross-sectional view and a front view, respectively, of a preferred mechanical structure of the distance-measuring unit;

FIG. 2c shows a view of the measuring element;

FIG. 2d shows a view of the sensor element;

FIG. 3a shows a functional block diagram of preferred embodiments of the individual assemblies of the analog evaluation unit; and

FIGS. 3b-3f show enlarged portions of the functional block diagram of FIG. 3a.

### DETAILED DESCRIPTION OF SPECIFIC EMBODIMENTS

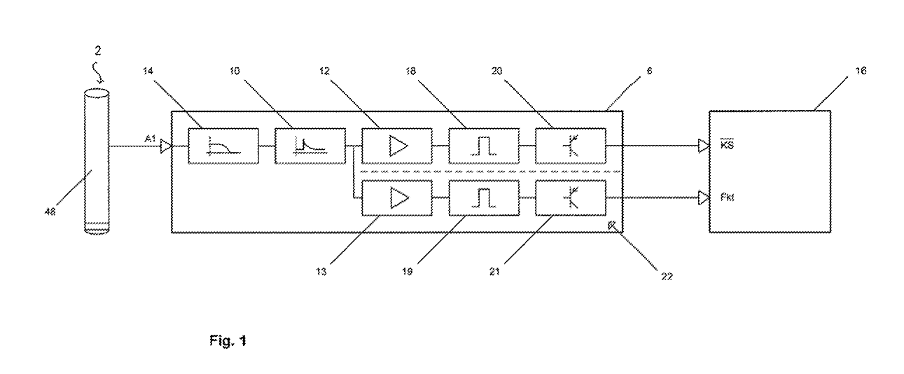

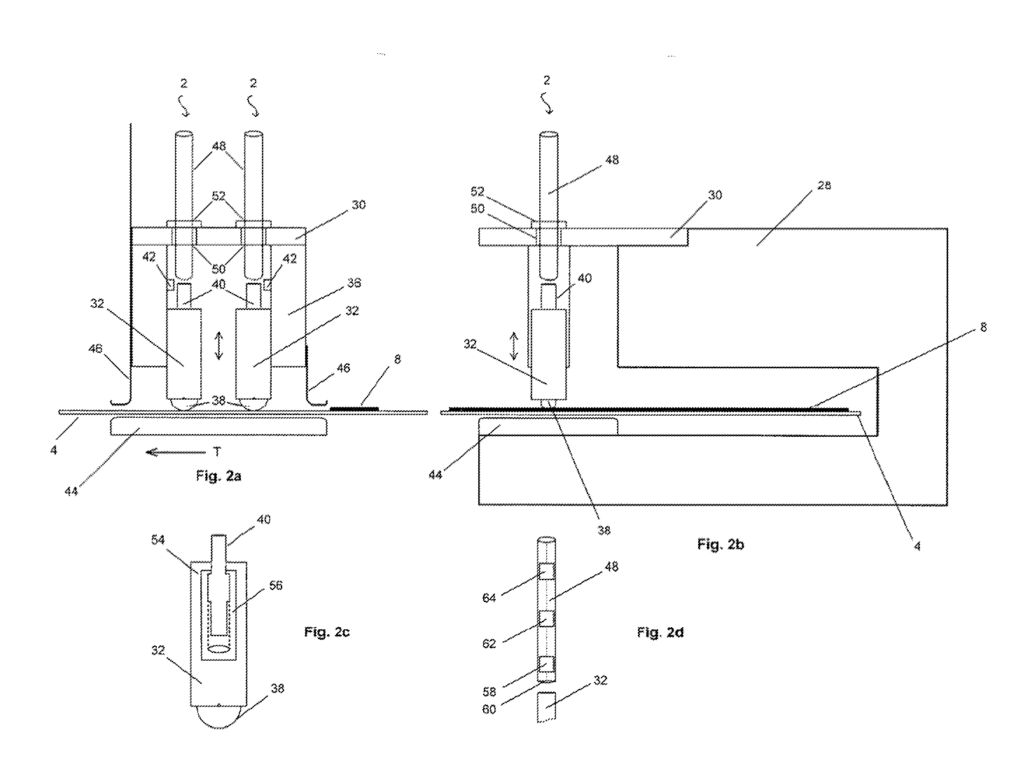

The device for adapting the control of a system for processing film webs, illustrated schematically in FIG. 1, especially a device for adapting the control of a blister pack machine, comprises a distance-measuring unit 2, which generates sensor signals tracking the change in thickness of the film web 4 (see FIG. 2a), and an analog evaluation unit 6, which is connected to the distance-measuring unit 2 and receives the sensor signals from the distance-measuring unit 2. In the example shown here, the distance-measuring unit 2 and the analog evaluation unit 6 together form a device for detecting splices 8 in the film web 4.

The analog evaluation unit 6 for the distance-measuring unit 2 comprises a low-pass filter 14, a differentiator 10 for differentiating the sensor signals, and also a comparator 12, downline from the differentiator 10, for comparing the voltage signals coming from the differentiator 10 with at least one previously determined limit value.

The sensor signals of the distance-measuring unit 2, which track the change in the thickness of the film web 4, are generated in a stationary sensor element 48. The sensor element 48 generates signals which depend on the distance between the sensor element 48 and a measuring element 32, which can move mechanically up and down. The measuring element 32 moves as a function of the thickness of the film web 4 as the film web 4 is moving past in a transport direction T under the permanently mounted sensor element 48 (see FIG. 2a). As it differentiates the sensor signals, the differentiator 10 thus generates voltage signals, which correspond to the speed of the measuring element 32.

On the basis of the comparison executed by the comparator 12, the analog evaluation unit 6 outputs decision signals to a central control unit 16, which is set up to supply a plurality of work stations of the blister pack machine with control commands. The control unit 16 will adapt the control commands which it generates for the work stations on the basis of the decision signals being received from the analog evaluation unit 6. In concrete terms, this means that certain subsequent processes such as the forming of blister pockets, the filling of these pockets with tablets, etc., will not be executed in the places of the film web 4 where splices 8 have been detected. In addition, these sections of the film web 4 which comprise splices 8 are also to be ejected at the end of the processing steps, that is, after the individual blisters have been stamped out of the lidded film web 4.

Most of the time, the voltage signal delivered by the comparator 12 already comprises an approximately square wave form. To obtain a reproducible square-wave signal of defined pulse width, the analog evaluation unit 6 can comprise a pulse-forming circuit 18 downline from the comparator 12. The square-wave signal thus arrives in the central control unit 16 by way of a switching output 20 of the analog electronic evaluation unit 6.

In the preferred embodiment shown here, the electronic analog evaluation unit 6 can also comprise a device 22 for function monitoring, which preferably also comprises a comparator 13, a pulse-forming circuit 19, and an associated switching output 21. Because of the irregular running behaviors and machine vibrations transferred by the measuring element 32, the sensor signal generated by the sensor element 48 comprises a certain spurious component. In the case of a fault such as a broken wire, a defective sensor, or a mechanical blockage of the plain bearing 36, these spurious signals fall below the threshold set in the comparator 13. This ensures that the sensor signals transmitted by the sensor element 48 are authentic, that the connection to the differentiator 10 is intact, and that the mechanical detect of the thickness of the film web 4 is proceeding properly. The device 22 for function monitoring also transmits its output signal to the central control unit 16.

A preferred embodiment of distance-measuring units 2 will now be described in greater detail with reference to FIGS. 2a-2d. In this example, two distance-measuring units 2 are mounted on a bracket 28 (FIG. 2b), which comprises a horizontally projecting mounting plate 30 for the two distance-measuring units 2. In the example shown here in FIGS. 2a-2d, the two distance-measuring units 2 are spaced apart by a distance of preferably 10-50 mm, and more preferably 15-30 mm, in the transport direction T of the film web 4. In the present embodiment, the two distance-measuring units 2 are arranged in series, parallel to the transport direction T of the film web 4, but it is also possible to arrange the two distance-measuring units 2 transversely to the transport direction T of the film web 4 with an offset to that transport direction T.

Each of the two distance-measuring units 2 is linked to an analog evaluation unit 6. The design of the circuit of the analog evaluation unit 6 for the second distance-measuring unit 2 is basically the same as that of the circuit for the first distance-measuring unit 2 according to FIG. 1.

The second distance-measuring unit 2 guarantees that a splice 8 will always be passing by at least one of the two distance-measuring units 2 at the necessary minimum speed. The background of this is that blister pack machines are usually operated in cycles in the sheet-forming area, which follows the detection area, so that, as a function of the machine speed, the film web 4 is stopped and put in motion again about 20-60 times per minute. When a splice 8 comes to a standstill directly in front of a distance-measuring unit 2, the generated sensor signal can be too weak for reliable detection, especially when the machine is running slowly and/or when the splice 8 is located on the side of the sheet facing away from the measuring element 32. In such a case, the binary signals of the two channels generated in the associated electronic evaluation unit 6 are logically linked and subjected to further processing. The two-channel configuration also represents a redundant system with a corresponding increase in functional reliability.

As shown in FIG. 2c, a measuring element 32 preferably consists of a measuring element housing 54 and a proximity plunger 40. The measuring element housing 54 is implemented as an elongated housing with a cavity, and the proximity plunger 40 is implemented as a pin-like element, which is supported so that it can slide up and down in the measuring element housing 54. One end of the proximity plunger 40 extends through an opening formed in the top of the measuring element housing 54. As can also be seen in FIG. 2c, the proximity plunger 40 can be pretensioned against the measuring element housing 54 and toward the top of the measuring housing 54 by a spring 56, which can be implemented as a spiral spring.

Each measuring element 32 is guided by a plain bearing 36, preferably a linear plain bearing, so that it can slide up and down. The plain bearings 36 are illustrated only schematically in FIGS. 2a and 2b. Many other types of bearings for the measuring element 32 are also conceivable.

In the lower part of the each measuring element 32, a roller 38, preferably a convex, high-grade steel roller, which rolls along the film web 4, is supported.

In this embodiment, it is the distance between the proximity plunger 40 and the sensor element 48 which is measured by the sensor element 48. Many other configurations of the measuring element, however, are also conceivable.

With reference now to FIG. 2d, it can be seen that the sensor element 48 is also formed as a vertically oriented, elongated element positioned above the measuring element 32. At its bottom end, the sensor element 48 comprises an oscillator 58, which generates an electromagnetic field by means of an oscillatory circuit. This alternating field emerges from the active surface 60 of the sensor element 48. Eddy currents are induced in the measuring element 32, which is made of metal, as it approaches the end face of the sensor element 48. These eddy currents withdraw energy from the oscillator 58. This results in a change in level at the output of the oscillator 58, a change which influences the analog output signal of the sensor element 48 as a function of the distance between the measuring element 32 and the sensor element 48. The change in level at the output of the oscillator is usually processed and amplified by a signal converter 62 and an output amplifier 64, thus resulting in the output signal of the sensor element 48.

The operational stroke range of the measuring element 32 is preferably limited to the small, contactless measuring range of the sensor element 48. As already suggested above, when the measuring element 32 is raised beyond the operational stroke range, the proximity plunger 40 is pushed by the distance sensor 48 into the measuring element housing 54. Mechanical stops 42 on the plain bearings 36 limit this stroke, so that the axial force on the distance-measuring unit 2 does not exceed the force preset by the spring constant of the spring 56.

A bracket 28 (FIG. 2b) connects the mounting plate 30 for the distance-measuring units to the web guide 44, preferably made of high-grade steel, and simultaneously allows the device to be mounted on the machine stand. The web guide 44 is preferably provided with rounded edges. A guide plate 46 is preferably attached to the web inlet and another such plate to the web outlet of the sensor system to calm the movement of the sheet. The guide plate 46 on the outlet side also serves the additional function of shielding the distance-measuring unit 2 from the heat coming from the heated forming station, which comes next in the sheet travel direction T, and in which the blister pockets are formed in the film web 4.

Under the assumption that the film web 4 always executes the same desired sequence of movements and that the splice 8 always has at least a certain minimum width, it is possible to provide only a single distance-measuring unit 2 and to know that the splices 8 will still be detected reliably. It is therefore clear that, in place of the previously described two distance-measuring units 2, it is possible to use only a single distance-measuring unit 2. In this case, the structure of the single distance-measuring unit 2 will be identical to the structure of each of the two previously described distance-measuring units 2.

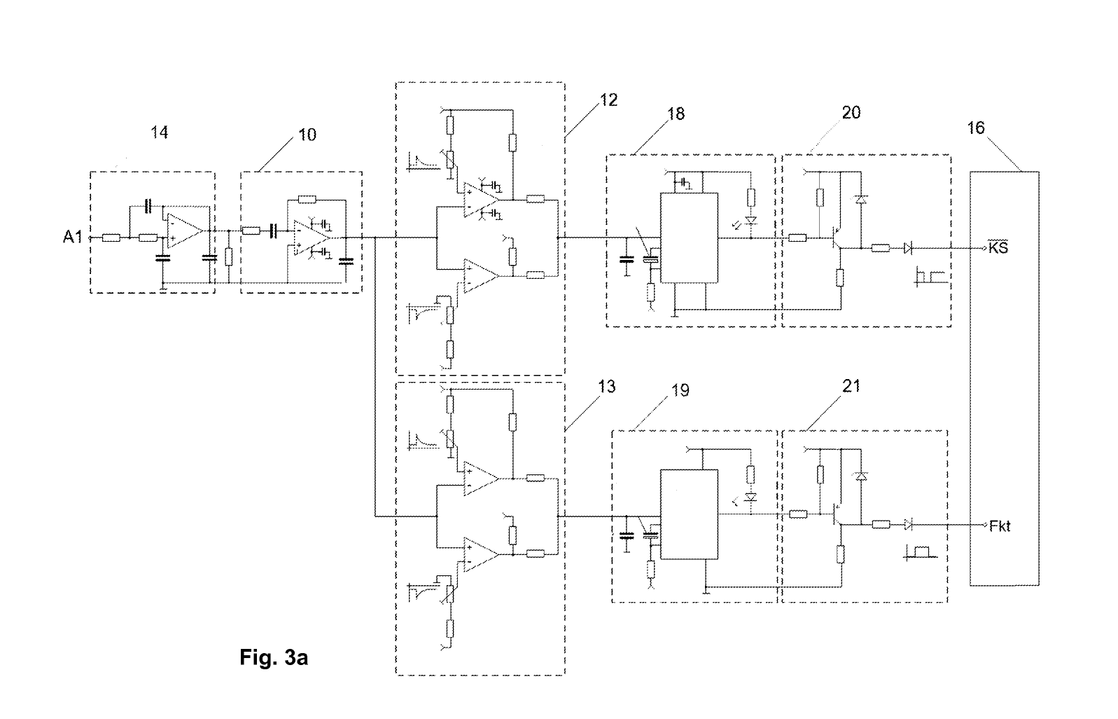

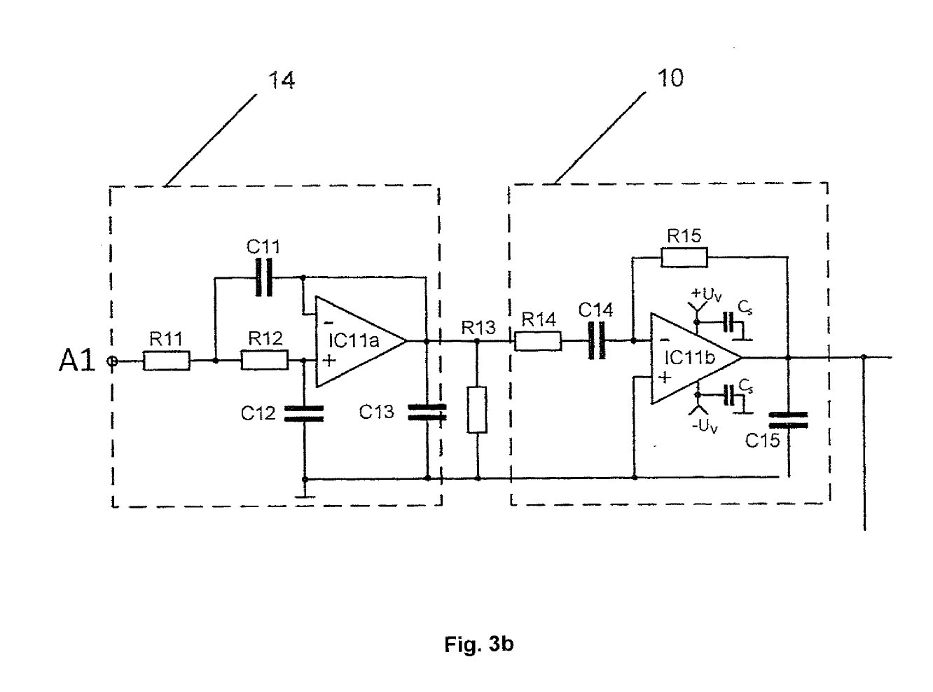

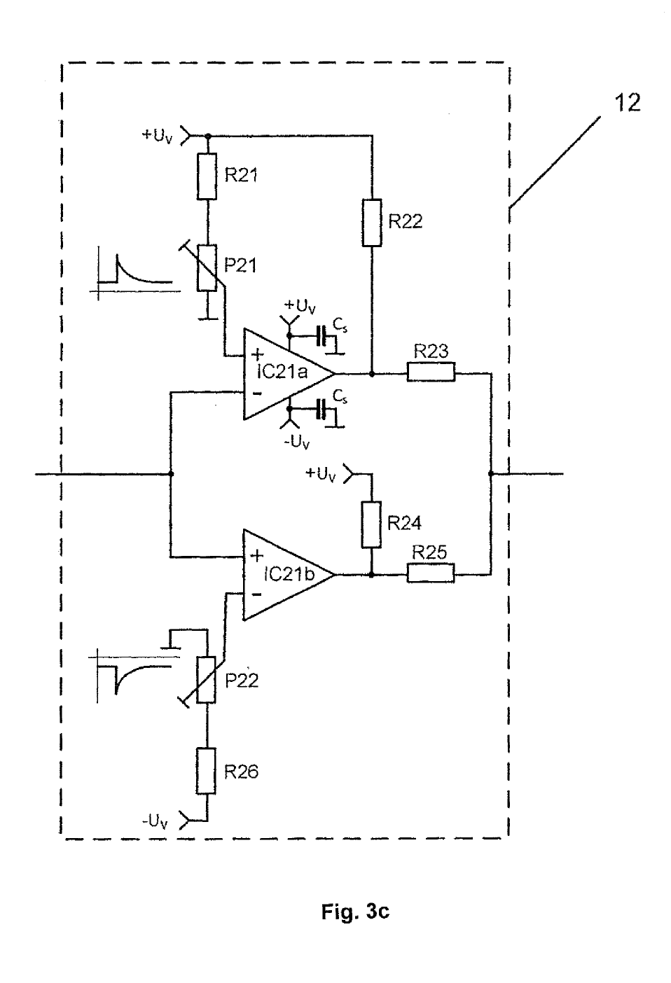

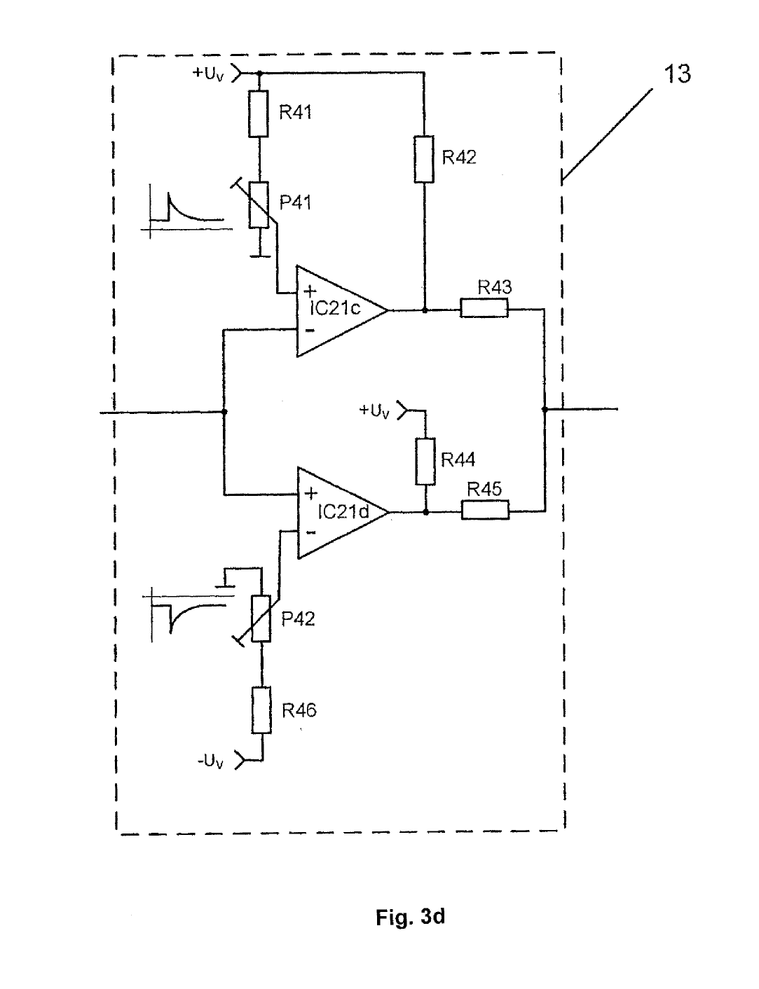

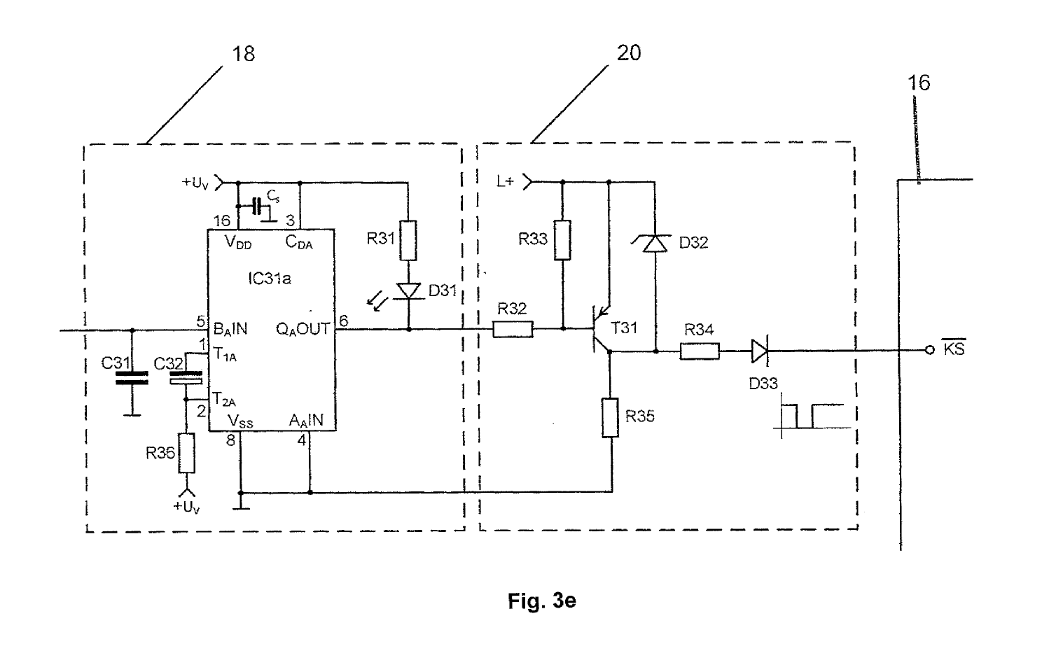

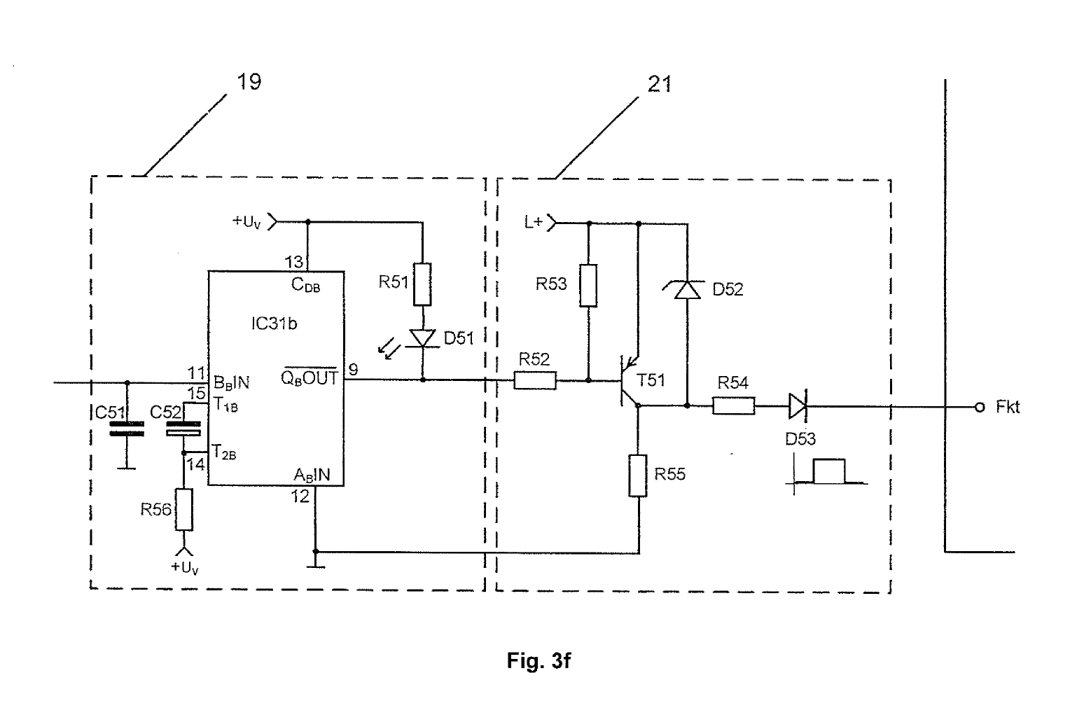

Important components of the electronic analog evaluation circuit 6 will now be described in greater detail with reference to FIGS. 3a-3f.

The differentiator 10, realized as an operational amplifier IC11b, is the main part of the circuit. The analog voltage signal A1 (0-10 V), corresponding to the position of the measuring element 32, is converted here into a voltage signal corresponding to the speed of the measuring element 32. Before that, the sensor signal passes through an active low-pass filter at IC11a, which suppresses the spurious high-frequency pulses caused by electromagnetic interference. C14 and R15 form the time constant. R14 and R15 together set the amplification factor of the inverting operational amplifier circuit and simultaneously stabilize it against the tendency to oscillate toward higher frequencies. An abrupt rise in the input signal (movement of the distance-measuring unit 2 up toward the splice 8 on the ascending flank of the splice 8) leads to a negatively polarized voltage peak at the output of IC11b. A movement of the distance-measuring unit 2 downward from the splice 8 (descending flank of the splice 8) brings about correspondingly a positively polarized voltage peak. In the circuit diagram, these pulse forms are sketched next to the trimming potentiometers P21 and P22 belonging to the window comparator, which is described below.

The comparator 12 is configured as a window comparator and consists of two circuit parts surrounding the comparators IC21a and IC21b. Here the voltage peaks coming from the differentiator 10 are monitored for limit values. Only appropriately strong signals corresponding to real splices 8 are recognized as such, whereas weaker signals caused by machine vibrations, for example, are suppressed. The limit values are set by the trimming potentiometers P21 and P22 to values in the range from −1.0 and 0 V (P22) and from 0 to +1.0 V (P21). The one-time setting is valid for all conceivable splices 8, independently of the film web 4 being processed. IC21a thus monitors positive voltage peaks (movement down from the splice 8), and correspondingly IC21b monitors negative voltage peaks (movement up toward the splice 8). In the present circuit, the outputs of the comparators IC21a and IC21b are equally able to signalize values exceeding the limits in either the positive or negative direction. If only one of the two flanks (ascending or descending) is to be monitored, it is also possible to use a simple comparator instead of a window comparator.

The pulse-forming circuit 18 comprises a timer IC31a, which forms the variable pulse width of the switching signal generated by the window comparator into a square-wave signal with a fixed pulse duration. C32 determines the pulse duration (approximately 100 ms). The LED D31 signalizes the “good” state, i.e., the absence of a splice (green). The transistor T31 generates the control signal required for the machine, this signal then being transmitted to the central control unit 16. So that the level can be adjusted properly, this transistor is supplied with the internal machine voltage L+(24 VDC). D33 prevents the voltage reversal of the binary outputs. D32 protects the transistor output from overvoltages. The series resistor R34 limits the output current and thus acts as overload protection.

In addition to the components mentioned above, the analog evaluation unit 6 can also comprise a device 22 for function monitoring. The device 22 for function monitoring comprises a comparator 13, a pulse-forming circuit 19, and a switching output 21. This structure corresponds essentially to the structure of the adhesion point branch. The interference signal which is transmitted to the distance-measuring sensor 48 as a result of uneven running of the film web 4 and machine vibrations is interpreted as a sign of life. The switching thresholds of the comparator 13 are to be set correspondingly lower. In contrast to the timer IC31a, timer IC31b has a negative switching output. In the operational state of the machine, it is assumed that one of the switching thresholds of the comparator 13 is triggered at least one per machine cycle. Correspondingly, the time constant is set by way of C52 to a value greater than the duration of the slowest machine cycle. Accordingly, the signal function (Fkt) is on level “low” before the machine starts, which is equivalent to an error state. The central control unit 16 must link this situation logically, so that the actual monitoring function is not activated by the control unit 16 until after the end of the first machine cycle after the startup of the machine.

The dual voltage supply to the analog evaluation unit 6 is generated from the internal machine supply voltage by a DC/DC converter.

Examples of implementations of the components shown in FIGS. 3a-3f are listed below:

| | | |
|---|---|---|
| Low-pass filter 14/ | IC11 | Double operational amplifier (e.g., LM 358) |
| Differentiator 10 | C11 | Capacitor 180-470 pF |
| | C12 | Capacitor 100-330 pF |
| | C13 | Capacitor 180-470 pF |
| | C14 | Capacitor 330 nF-2.2 μF |
| | C15 | Capacitor 1.0-4.7 nF |
| | Cₛ | Decoupling capacitors 47-220 nF |
| | R11 | Metal film resistor 3.3-10 kΩ |
| | R12 | Metal film resistor 3.3-10 kΩ |
| | R13 | Metal film resistor 1.0-4.7 kΩ |
| | R14 | Metal film resistor 0.47-2.2 MΩ |
| | R15 | Metal film resistor 0.47-2.2 MΩ |
| Comparator, | IC21 | Quad comparator (e.g., LM 339) |
| Adhesion Point 12 | Cₛ | Decoupling capacitors 47-220 nF, ceramic |
| | P21 | Multi-ganged potentiometer 3.3-22 kΩ |
| | P22 | Multi-ganged potentiometer 3.3-22 kΩ |
| | R21 | Metal film resistor 33-220 kΩ |
| | R22 | Metal film resistor 1.8-6.8 kΩ |
| | R23 | Metal film resistor 22-100 kΩ |
| | R24 | Metal film resistor 1.8-6.8 kΩ |
| | R25 | Metal film resistor 22-100 kΩ |
| | R26 | Metal film resistor 33-220 kΩ |
| Comparator, | P41 | Multi-ganged potentiometer 3.3-22 kΩ |
| Function Monitoring | P42 | Multi-ganged potentiometer 3.3-22 kΩ |
| 13 | R41 | Metal film resistor 33-220 kΩ |
| | R42 | Metal film resistor 1.8-6.8 kΩ |
| | R43 | Metal film resistor 22-100 kΩ |
| | R44 | Metal film resistor 1.8-6.8 kΩ |
| | R45 | Metal film resistor 22-100 kΩ |
| | R46 | Metal film resistor 33-220 kΩ |
| Pulse-Former, | IC31 | Precision monoflop (e.g., CD 4538) |
| Adhesion Point 18 | T31 | Transistor PNP (e.g., BC 327) |
| | D31 | LED green |
| | D32 | Zener diode (e.g., ZPD 36) |
| | D33 | Diode (e.g., 1N 4148) |
| | C31 | Capacitor 47-220 nF |
| | C32 | Electrolytic tantalum capacitor 3.3-22 μF |
| | Cₛ | Decoupling capacitor 47-220 nF, ceramic |
| | R31 | Metal film resistor 1.0-4.7 kΩ |
| | R32 | Metal film resistor 33-220 kΩ |
| | R33 | Metal film resistor 1.8-6.8 kΩ |
| | R34 | Metal film resistor 0.68-3.3 kΩ |
| | R35 | Metal film resistor 33-220 kΩ |
| | R36 | Metal film resistor 0.47-2.2 MΩ |
| Pulse-Former, | T51 | Transistor PNP (e.g., BC 327) |
| Function Monitoring | D51 | LED green |
| 19 | D52 | Zener diode (e.g., ZPD 36) |
| | D53 | Diode (e.g., 1N 4148) |
| | C51 | Capacitor 47-220 nF |
| | C52 | Electrolytic tantalum capacitor 3.3-22 μF |
| | Cₛ | Decoupling capacitor 47-220 nF, ceramic |
| | R51 | Metal film resistor 1.0-4.7 kΩ |
| | R52 | Metal film resistor 33-220 kΩ |
| | R53 | Metal film resistor 1.8-6.8 kΩ |
| | R54 | Metal film resistor 0.68-3.3 kΩ |
| | R55 | Metal film resistor 33-220 kΩ |
| | R56 | Metal film resistor 0.47-2.2 kΩ |

If two distance-measuring units 2 are to be used, two of the circuits shown in FIG. 3a will be present.

The distance-measuring unit 2 does not have to be configured as an inductive distance sensor. On the contrary, any other known type of distance-measuring unit can be used, such as those which operate with optical detection of a mechanically moved plunger.

The sensor signals of the sensor element 48 are usually in the range of 0-10 V DC.

The sensor element 48 can generate current signals instead of voltage signals.

With respect to the detection of splices 8, the device described here is not subject to any limitations. It detects splices 8 in all types and thicknesses of film webs 4, preferably aluminum or plastic sheets, and is adapted to detection in cycled operation. Also irrelevant are the type of adhesive and the arrangement of the thickened area at the top or bottom of the sheet web 4 to be monitored.

1. A device for adapting the control of a system for processing a film web, the system being a blister pack machine, the device comprising:
a central control unit, which is adapted to supply a plurality of work stations of the system with control commands, and
a device for detecting splices in the film web,
wherein the device for detecting splices comprises a distance-measuring unit comprising a measuring element, which is mechanically movable as a function of a thickness of the film web, and which is adapted to generate sensor signals tracking a change in thickness of the film web;
wherein the device for detecting splices also comprises an analog evaluation unit, which is connected to the distance-measuring unit and receives the sensor signals from the distance-measuring unit, wherein the analog evaluation unit comprises at least one differentiator for differentiating the sensor signals and for generating voltage signals corresponding to a speed of the measuring element, and further comprises a comparator, downline from the differentiator, for comparing the voltage signals transmitted by the differentiator with at least one previously determined limit value;
wherein, on the basis of the comparison, the analog evaluation unit outputs decision signals to the control unit; and
wherein the control unit is adapted to adapt the control commands for the work stations on the basis of the decision signals of the analog evaluation unit.

2. The device of claim 1, wherein the comparator is a window comparator.

3. The device of claim 1, wherein the analog evaluation unit comprises a pulse-forming circuit downline from the comparator.

4. The device of claim 1, wherein the analog evaluation unit comprises a device for function monitoring.

5. The device of claim 4, wherein the measuring element is guided by a plain bearing.

6. The device of claim 1, wherein the distance-measuring unit is configured as an inductive analog sensor, which comprises a sensor element in addition to the measuring element, wherein the measuring element of the distance-measuring unit is configured as a proximity element, which is supported movably relative to the sensor element in a direction perpendicular to a transport direction of the film web.

7. The device of claim 6, wherein the sensor element and the measuring element are functionally connected to each other by induction in such a way that a change in a distance between the measuring element and the sensor element brings about a change in a damping of the sensor element by the measuring element.

8. The device of claim 1, wherein a sensor signal output by the distance-measuring unit is an analog signal.

9. The device of claim 8, wherein the measuring element comprises a roller in a lower area thereof, which rolls along the film web.

10. The device of claim 1, wherein the analog evaluation unit comprises a low-pass filter upline from the differentiator.

11. The device of claim 1, wherein a second distance-measuring unit is arranged downline, with respect to a transport direction of the film web, from the first distance-measuring unit.

12. The device of claim 11, wherein the distance between the first distance-measuring unit and the second distance-measuring unit in the transport direction of the film web is in the range of 10-50 mm.

13. The device of claim 11, wherein the distance between the first distance-measuring unit and the second distance-measuring unit in the transport direction of the film web is in the range of 15-30 mm.

14. A device for adapting the control of a system for processing a film web, the system being a blister pack machine, the device comprising:
a central control unit, which is adapted to supply a plurality of work stations of the system with control commands, and
two distance-measuring units, which are arranged in series a previously determined distance apart in a transport direction of the film web,
wherein each of the two distance-measuring units comprises a measuring element mechanically movable as a function of a thickness of the film web, and wherein each of the two distance-measuring units is adapted to generate sensor signals tracking a change in a thickness of the film web;
wherein the control unit is adapted to evaluate the sensor signals of the two distance-measuring units and to adapt the control commands for the work stations on the basis of the evaluation of the sensor signals.
